(19) United States
(12) Patent Application Publication
(10) Pub. No.: US 2024/0107209 A1
(43) Pub. Date: Mar. 28, 2024

(54) SPEAKER MOUNTING ASSEMBLY

(71) Applicant: Lithe Audio LTD, Salfords (GB)

(72) Inventor: Wesley SIU, Salfords (GB)

(21) Appl. No.: 18/475,483

(22) Filed: Sep. 27, 2023

(30) Foreign Application Priority Data
Sep. 28, 2022 (GB) 2214233.5

(51) Int. Cl. H04R 1/02

(52) U.S. Cl. CPC H04R 1/021; H04R 1/025; H04R 1/026; H04R 2201/025

(57) ABSTRACT

A speaker mounting assembly for mounting a speaker in multiple configurations, the speaker mounting assembly comprising a bracket having a substantially V-shaped profile, wherein the bracket comprises a first mounting plate and a second mounting plate meeting at a flattened vertex, wherein the flattened vertex forms a third mounting plate, and fixing apertures in each of the first, second and third mounting plates.

### CROSS-REFERENCE TO RELATED APPLICATIONS

The present application claims priority to GB Patent Application Serial No. 2214233.5, filed Sep. 28, 2022, the contents of which are incorporated herein by reference in its entirety.

### FIELD

The present disclosure relates to an improved mounting assembly for a loudspeaker and a speaker system mounted using the improved speaker mounting assembly.

### BACKGROUND

Wall mounted speakers (loudspeakers) and speakers for installation in corners or under eaves are known. This allows for aesthetic advantages, frees up floor space and also allows for the acoustic output within a room, venue or outdoor space to be planned according to requirements. Generally, “corner speakers” have a 90 degree triangular design to allow for placement into the corners of a room or building, wherein the speaker enclosure is mounted flush into the corner. Such corner speakers are used in the home and also in public buildings such as schools, commercial buildings such as hotels, restaurants, conference and entertainment venues. It is also known to mount corner speakers onto a wall or ceiling both horizontally and vertically. Further, it is also possible to mount a cluster of multiple corner speakers to achieve greater sound coverage.

Conventionally, speakers are mounted within a room using a pivotable bracket having a support arm connected to a mounting plate at a first end, with the mounting plate mounted to the mounting surface. For example, when used for mounting a corner speaker a mounting plate is screwed into the wall at one side of the corner. A recess is also defined in the speaker enclosure to receive an insert portion at a second end of the support arm to retain the support arm and so hold the corner speaker in place. Known corner speakers also use similar brackets, which can include a solid triangular prism shaped mounting plate to be screwed into a wall at the corner of a room. If the same speaker is to be used in an alternative position; for example, as a cluster of 2, 3, or 4 speakers to emit multi-directional sound, then an alternative mounting assembly is used; for example, a floor-mounted support frame is used.

Existing mounting assemblies for corner speakers require several different fixings for mounting within a corner, for mounting as a cluster and for mounting for either indoor or outdoor use. To achieve the required aesthetic and acoustic properties, it is desirable for corner speakers to sit neatly within a corner and so mounting assemblies commonly have a flat, planar profile. A slidable mounting assembly is known, wherein plates or “sliders” are mounted to a wall or ceiling and are each configured to mate with a corresponding recess in the speaker enclosure. However, such slidable assemblies are not suitable for mounting corner speakers to a corner; for example, for outdoor use. Furthermore, the slidable mounting assemblies are not suitable for mounting multiple corner speakers as a cluster or for floor-mounting the speakers.

### SUMMARY

There is a need to simplify the mounting assembly to allow the same corner speakers having a triangular design to be used in multiple positions within a home or venue and for both indoor and outdoor use. Furthermore, there is a limit to possible configurations of existing corner speakers. If a corner speaker is mounted from one of its flat, side faces, this is convenient for installation but limits the direction in which sound can be emitted from the speaker.

The present disclosure sets out to provide an improved mounting assembly for a loudspeaker, which alleviates the problems described above.

In one aspect, the disclosure provides a speaker mounting assembly for mounting a speaker in multiple configurations, the speaker mounting assembly comprising:
a bracket having a substantially V-shaped profile, wherein the bracket comprises a first mounting plate and a second mounting plate meeting at a flattened vertex, which forms a third mounting plate, and fixing apertures in each of the first, second and third mounting plates.

In the context of the present disclosure, “speaker” is used to refer to a loudspeaker.

The speaker mounting assembly of the present disclosure allows for multiple mounting configurations for one or more speakers, for example in the form of speaker enclosures housing a loudspeaker. The configuration including multiple mounting positions and multiple fixing apertures allows for alternative configurations for mounting the speaker mounting assembly and also for mounting the speaker enclosure to the mount. Thus, the present disclosure allows the same speaker mounting assembly to be used to mount a speaker enclosure into an internal corner of a room; at the corner of two outside walls, on a table top using the speaker mounting assembly as a support means; and also, to floor-mount or wall-mount one or more speaker enclosures. Thus, the present disclosure allows for ease of installation and flexibility on-site to decide how best to achieve the required acoustic output using only a single type of speaker mounting assembly. A user can also use the same speaker mounting assembly to move speakers between positions depending on their requirements. Furthermore, the present disclosure allows the same speaker mounting assembly to be used to mount multiple speakers in a cluster formation, including configurations wherein multiple corner speakers are used to direct sound around 90, 180, 270 or 360 degrees.

Preferably, the angle between the internal walls of the first mounting plate and the second mounting plate is about 90 degrees.

Preferably, the internal walls of the first mounting plate and second mounting plate are planar and the outer walls of the first mounting plate and the second mounting plate are multifaceted.

The shape is configured to allow for a triangular corner speaker to be held securely and mounted flush into the corners of a room and onto walls and ceilings, whilst the outer walls allow for alternative mounting configurations.

Preferably, the speaker mounting assembly comprises a shaped bracket having an inner receiving surface that is substantially V-shaped and an opposing, outer surface that is also substantially V-shaped but is truncated to comprise a strip at the apex of the V-shape.

More preferably, the third mounting plate has a stepped configuration. More preferably, the third mounting plate comprises a recess. Preferably, the third mounting plate comprises a cuboidal recess, which is centrally positioned along the length of the third mounting plate.

The “length” of the third mounting plate is understood to be the longest dimension of the third mounting plate.

The recess allows for cables/wiring to be fed out of the speaker enclosure when the speaker mounting assembly is mounted at a corner, without interfering with mounting of the speaker enclosure to the bracket.

Preferably, the speaker mounting assembly further comprises at least one spacer.

A spacer within the speaker mounting assembly ensures that it is not possible to compress a speaker enclosure mounted therein. This prevents structural damage to the speaker enclosure.

Preferably, the at least one spacer comprises a rigid material.

Preferably, the speaker mounting assembly comprises a first spacer at a first end of the speaker mounting assembly and a second spacer at a second end of the speaker mounting assembly.

Preferably, the speaker mounting assembly further comprises at least one removable triangular cover.

Preferably, the speaker mounting assembly further comprises two removable triangular covers, wherein each removable triangular cover is attached at the open end faces of the speaker mounting assembly.

The “end faces” of the speaker mounting assembly are understood to be at each end of the length of the speaker mounting assembly, wherein the “length” is understood to be the longest dimension of the speaker mounting assembly. The removable triangular cover prevents water, dust and any other contaminants that could damage the speaker/speaker enclosure from entering the rear of the speaker enclosure when it is mounted into a corner. The removable cover can be snapped from the speaker mounting assembly if it is not required; for example, when the speaker mounting assembly is used in an alternative mounting configuration.

Preferably, the speaker mounting assembly further comprises a detachable support arm.

Preferably, the detachable support arm comprises a removable spike at one end thereof.

It is understood that in the context of the present disclosure, a spike is a pointed element suitable for insertion into the ground. The detachable support arm of the present disclosure allows the speaker mounting assembly to be used for floor-standing support of a speaker enclosure. In addition, a spike at one end allows the detachable support arm to pierce soft ground, such as for use in a grassed area.

Preferably, the detachable support arm is pivotable.

Preferably, the detachable support arm is pivotably mounted to the bracket.

Preferably, the detachable support arm comprises a base, a pivot point and a mounting arm.

The pivotable arm of the detachable support arm allows a user to adjust the position of the speaker mounting assembly and so the speaker according to the required direction of acoustic output.

Preferably, the speaker mounting assembly further comprise at least one screw receivable into any one or more of the fixing apertures in the first, second and third mounting plates. More preferably, the speaker mounting assembly further comprise a plurality of screws receivable into any one or more of the fixing apertures in the first, second and third mounting plates.

Preferably, the speaker mounting assembly further comprises resilient covers for the or each screw.

More preferably, the speaker mounting assembly further comprises rubber covers for the or each screw.

The rubber screw covers or bungs protect the fixings and are also waterproof to prevent any water entering the speaker enclosure, which is particularly important for outdoor use.

In a second aspect, the present disclosure provides a speaker system comprising at least one speaker mounting assembly as previously described and at least one speaker attached thereto.

In another aspect, the present disclosure provides a speaker system comprising at least one speaker mounting assembly as previously described and at least one speaker enclosure attached thereto, wherein the or each speaker enclosure comprises a speaker.

Preferably, the speaker mounting assembly comprises at least one spacer, wherein the or each spacer traverses a gap between the speaker mounting assembly and a speaker enclosure mounted thereon.

For the purposes of clarity and a concise description, features are described herein as part of the same or separate embodiments; however, it will be appreciated that the scope of the disclosure may include embodiments having combinations of all or some of the features described.

### BRIEF DESCRIPTION OF THE DRAWINGS

The inventive aspects of the disclosure will now be described by way of example with reference to the accompanying drawings, in which:

FIG. 1 is a side perspective view of the speaker mounting assembly of the present disclosure, showing the speaker mounting assembly attached to a speaker enclosure for mounting within a corner;

FIG. 2 is a rear perspective view of the speaker mounting assembly of FIG. 1, showing the mounting assembly attached to a speaker enclosure for mounting within a corner;

FIG. 3 is a cross-sectional view through section A-A shown in FIG. 2, showing the speaker mounting assembly attached to a speaker enclosure for mounting within a corner;

FIG. 4a is a perspective view of the speaker enclosure attached to the speaker mounting assembly of FIGS. 1 to 3;

FIG. 4b is a view from above of the speaker enclosure with rubber bungs removed to show the fixings between the speaker enclosure and the speaker mounting assembly;

FIG. 4c is a view from above of the speaker enclosure with rubber bungs in place over the fixings between the speaker enclosure and the speaker mounting assembly;

FIG. 5 is a side perspective view of the speaker mounting assembly of the present disclosure, showing the speaker mounting assembly attached to a speaker enclosure for mounting at a corner;

FIG. 6 is a side view of the speaker mounting assembly of the present disclosure, showing the speaker mounting assembly attached to a speaker enclosure for mounting at a corner;

FIG. 7 is a side view of the speaker mounting assembly of the present disclosure, showing the speaker mounting assembly attached to a speaker enclosure for mounting on a surface;

FIG. 8 is a rear view of the speaker mounting assembly of the present disclosure, showing the speaker mounting assembly attached to a speaker enclosure for mounting on a surface;

FIG. 9 is a side view of the speaker mounting assembly of the present disclosure, showing the speaker mounting assembly attached to a speaker enclosure mounted in a floor-standing position; and

FIG. 10 is a perspective side view of the speaker mounting assembly of the present disclosure, showing the speaker mounting assembly attached to a speaker enclosure in a wall-mounted position.

### DETAILED DESCRIPTION

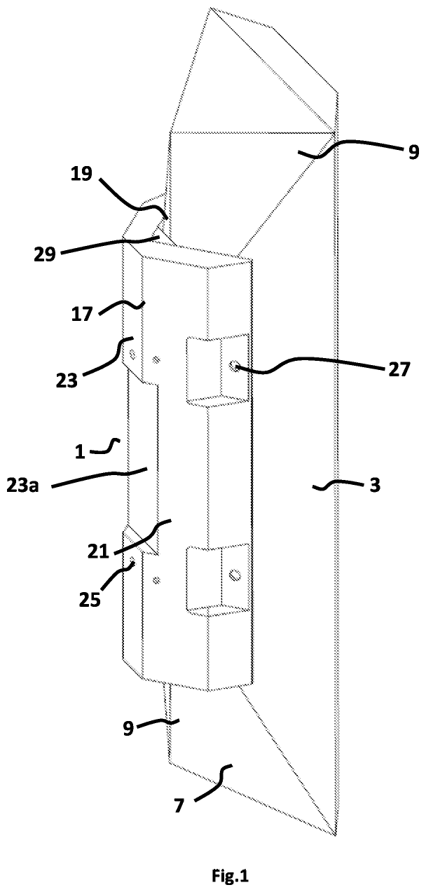

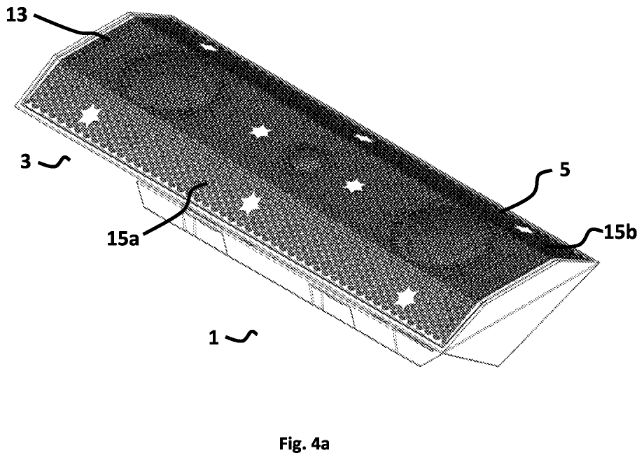

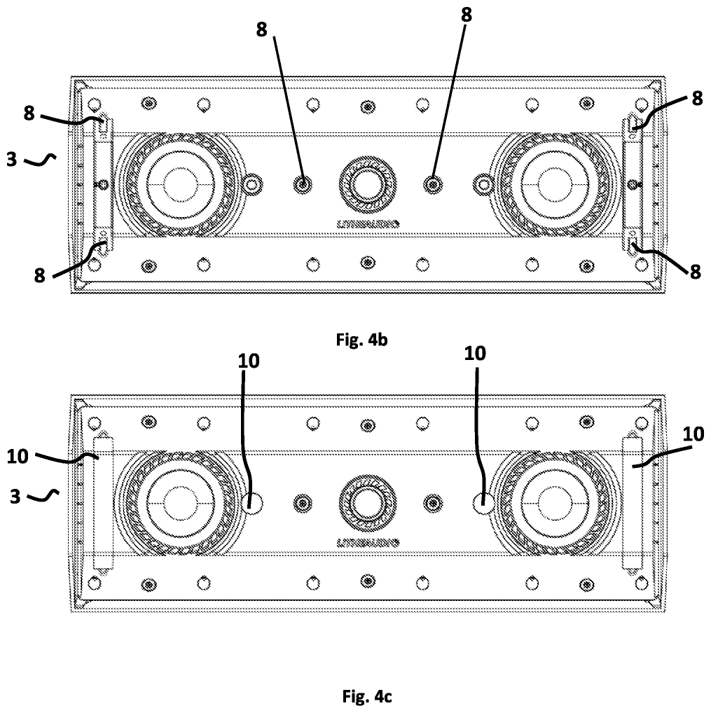

Referring to FIG. 1, a preferred embodiment of the speaker mounting assembly 1 of the present disclosure is shown attached to a speaker enclosure 3. The speaker enclosure 3 has a generally triangular design suitable for mounting into the corner of a room. Referring to FIGS. 1, 3 and 4, both the outward, sound-emitting face 5 of the speaker enclosure 3 and the inward, non-sound-emitting face 7 of the speaker enclosure 3 are multifaceted. The speaker enclosure 3 comprises a plurality of loud speakers (not shown). The sound-emitting face 7 of the speaker enclosure comprises a grill through which sound is emitted in use. Referring to FIGS. 4a, 4b and 4c, the grill/mesh cover over the sound-emitting face 7 of the speaker enclosure 3 is removable to access fixing screws 8 for installation of the speaker enclosure 3 to the speaker mounting assembly 1. In a preferred embodiment, the grill/mesh cover is magnetically secured to the speaker enclosure. However, in alternative embodiments, the grill/mesh cover is mechanically secured to the speaker enclosure Rubber covers/bungs 10 are also removable to allow access to the fixing screws at the front sound-emitting face of the speaker enclosure after removing the grill. The rubber bungs protect the fixing screws and ensure that the fixings are waterproof.

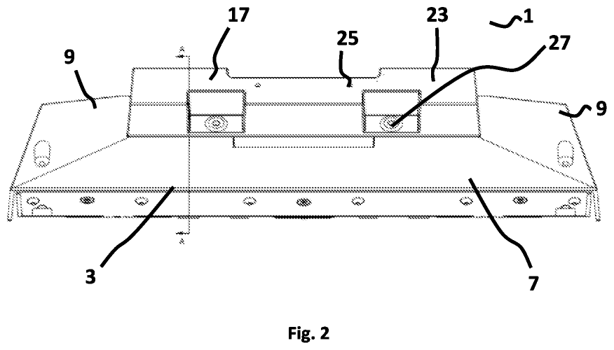

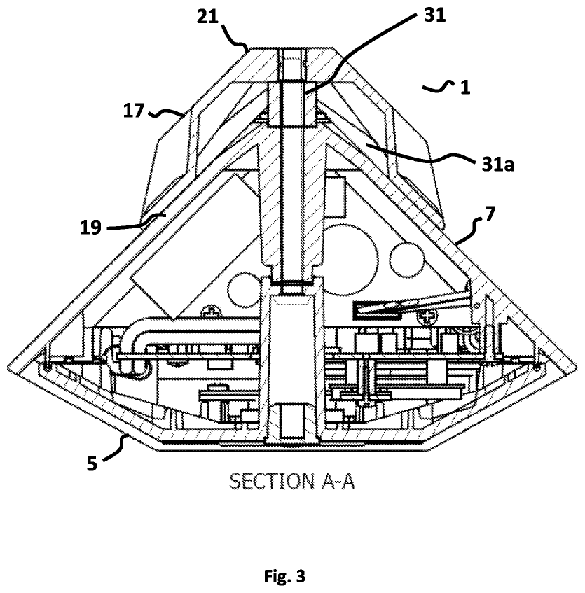

Referring to FIG. 3, the speaker enclosure 3 slopes towards a truncated apex 11 on the non-sound-emitting face 7. Referring to FIGS. 1 and 2, the ends 9 of the speaker enclosure 3 also slope inwardly towards this truncated apex 11. Referring to FIG. 4, the outward, sound-emitting face 5 of the speaker enclosure 3 comprises a planar surface 13, which is central between a first and second sloping face 15a, 15b. Thus, as shown in FIG. 3, the sound emitting face 5 of the speaker enclosure has a cross-section that is an isosceles trapezoid.

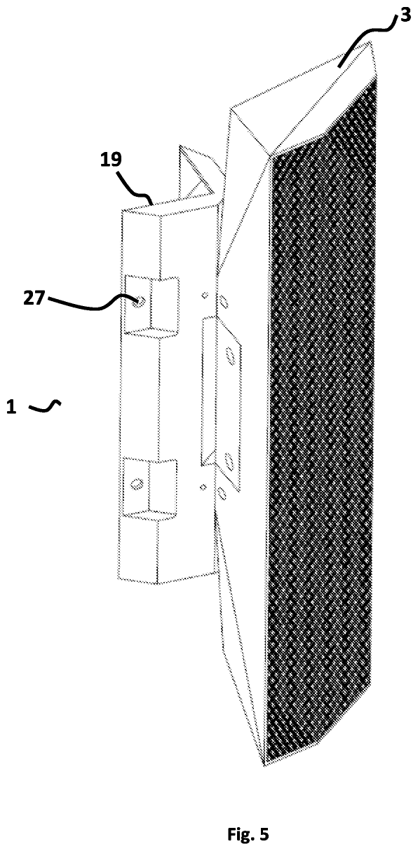

Referring to FIGS. 1, 2 and 3, the speaker mounting assembly 1 of the present disclosure comprises a shaped bracket 17 having an inner, speaker-receiving surface 19 that is substantially V-shaped and comprises a first mounting surface and a second mounting surface. The bracket 17 comprises an opposing, outer surface 21 that is also substantially V-shaped but is truncated to comprise a flat strip 23 at the apex of the V-shape, which forms a third mounting surface. As shown in FIG. 1, the flat strip 23 at the apex of the V-shaped outer surface 21 has a stepped configuration such that the flat strip 23 comprises a recess 23a, which is centrally positioned along the length of the flat strip 23. The recess 23a allows for cables/wiring to be fed out of the speaker enclosure when the speaker mounting assembly 1 is mounted at a corner. The mounting assembly 1 is integrally formed—i.e., it is formed of a single moulded piece. The speaker mounting assembly comprises a plurality of fixing holes 25 for attachment of the speaker mounting assembly 1 to a support (not shown). The mounting assembly 1 further comprises fixing holes 27 for attachment of the mounting assembly 1 to a speaker enclosure 3. The fixing holes 27 sit within recesses in the bracket 17. In a preferred embodiment, the fixing holes 27 sit within cuboidal recesses in the bracket 17, which ensure that when fixings, such as screws are inserted to fix a speaker enclosure 3 to the bracket 17, the fixings do not interfere with the positioning of the bracket flush into a corner. In the embodiment shown in FIGS. 1 to 4, the inner speaker-receiving surface 19 of the speaker mounting assembly 1 further comprises a pair of removable, triangular cover pieces 29. In use, the cover pieces 29 prevent the ingress of water, dust etc. to the rear of the speaker enclosure 3, which could potentially damage the components of the speaker. In alternative mounting configurations as described with regard to FIGS. 5 to 10, if the triangular cover piece is not required, it can be snapped off by hand and disposed of.

Referring to FIGS. 1 and 3, to mount the speaker mounting assembly 1 into the corner of a room, wherein the support is provided by the two walls adjacent to the corner, the bracket 17 of the speaker mounting assembly 1 is first attached to the corner of the room using suitable fixings through holes 25 in the flat strip 23 of the mounting assembly 1. The non-sound-emitting face 7 of the speaker enclosure 3 can then be fitted to sit within the inner, V-shaped, speaker-receiving surface 19 of the mounting assembly 1. The speaker enclosure 3 is fixed in the required position using suitable fixing means through the speaker enclosure 3 and via the fixing holes 27, to the bracket 17 of the speaker mounting assembly 1, such as screws.

The speaker mounting assembly 1 further comprises at least one removable separator or spacer 31, which is used to prevent structural damage to the speaker enclosure 3 during fitting to the bracket 17 of the speaker mounting assembly 1. Referring to FIG. 3, a spacer 31 sits within a recess 31a between the speaker enclosure 3 and the bracket 17. In a preferred embodiment, the spacer 31 also comprises a layer of adhesive to attach to the bracket 17 before installation of the speaker enclosure. The separator/s 31 ensures that the speaker enclosure cannot be damaged during installation when the speaker enclosure 3 is screwed to the bracket and so to the support, such as the corner of two walls, to which the speaker enclosure 3 is mounted.

With reference to FIG. 3, when the speaker enclosure 3 is installed into the corner of a room, there is a gap, recess 31a between the inward non-sound-emitting face of the speaker enclosure 3 and the speaker mounting assembly 1, which allows for cables/wiring to be fed through the rear of the speaker mounting assembly and remain out of view. The front view of the sound-emitting face 5 of the speaker enclosure 3, when installed in a corner, conceals all wiring and also conceals the speaker mounting assembly 1 so that the speaker enclosure 3 is seen to fit flush into the corner of the room. As previously described, the flat strip 23 of the bracket 17 also comprises a recess 23a, which allows for cables/wiring to be fed out of the speaker enclosure when mounted to the speaker mounting assembly 1 at a corner.

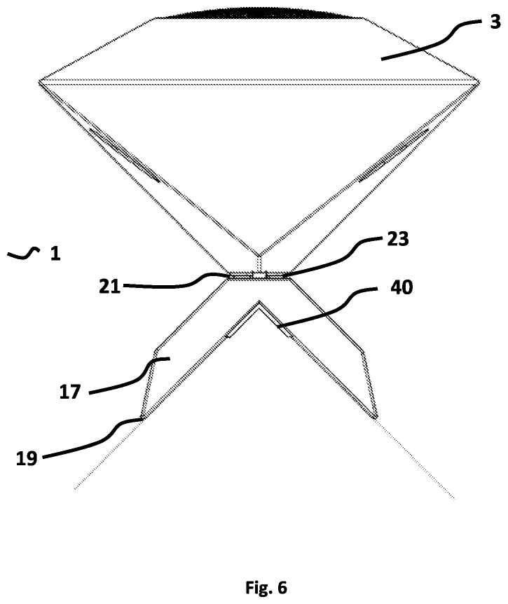

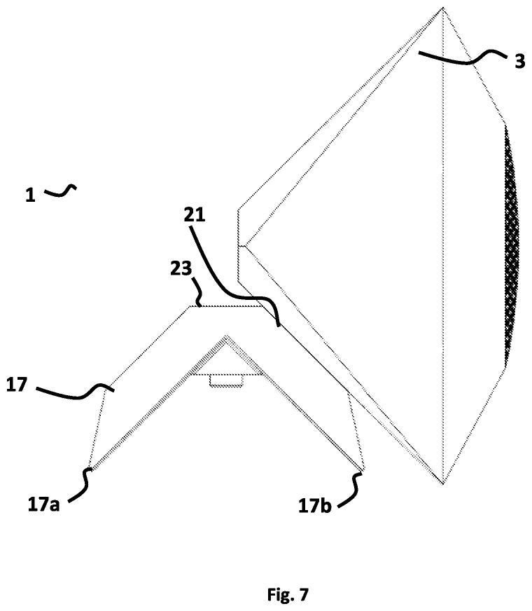

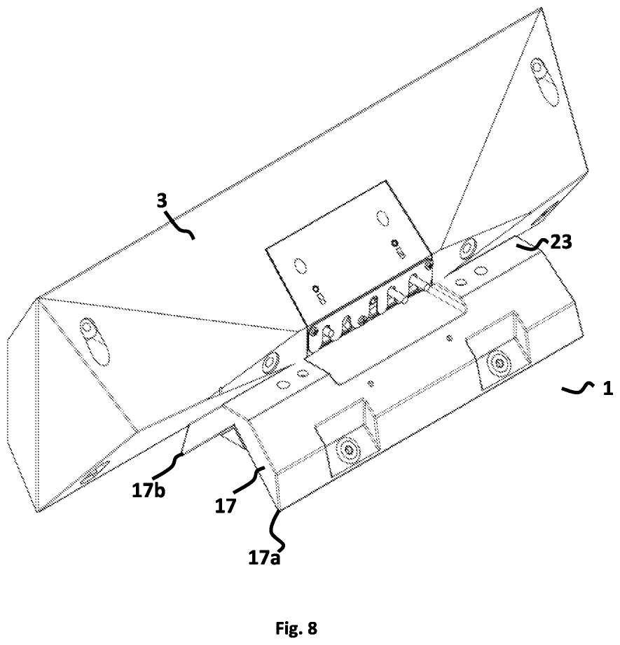

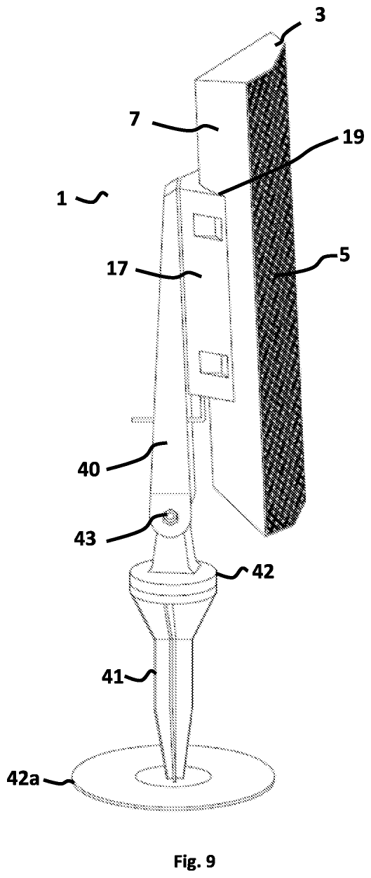

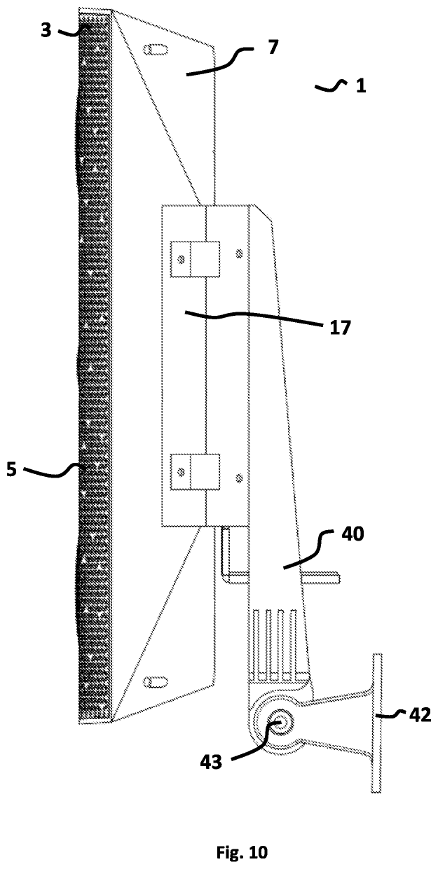

As shown in FIGS. 5 to 10, the speaker mounting assembly described herein can be used to fit a triangular speaker in multiple orientations and positions for a variety of uses. The support to which the speaker mounting assembly is attached can be:
i) A pair of walls at the corner of an internal room (speaker positioned vertically) or between a wall of a room and the eaves (speaker position horizontally), as shown in FIGS. 1 to 4;
ii) At the corner of an external wall, as shown in FIGS. 5 and 6;
iii) On a surface, such as a table top, as shown in FIGS. 7 and 8; or
iv) On a floor, wall or ceiling mounted pivotable pole/support arm, as shown in FIGS. 9 and 10.

Referring to FIG. 5, the speaker mounting assembly of the present disclosure is shown in use to mount a speaker enclosure 3 at the corner of an external wall. The same configuration could be used internally; for example, to fit the speaker enclosure 3 to a column within a room. Using the same reference numerals as for FIGS. 1-4, the alternative position of the speaker enclosure allows a user to use exactly the same speaker mounting assembly for the alternative support position.

As previously described, the speaker mounting assembly 1 comprises a shaped bracket 17. Referring to FIGS. 5 and 6, in this configuration, the substantially V-shaped inner surface 19 of the bracket 17 is fitted in use at the corner 40 of two adjacent walls. In use, the bracket 17 is first fixed to a corner using suitable fixing means, such as screws, attached through fixing holes 27. The opposing, outer surface 21 of the shaped bracket 17 is fixed to the rear face of the speaker enclosure 3 using suitable fixing means, such as screws, attached through the fixing holes 25 along the flat strip 23 at the apex of the V-shaped bracket 17.

Referring to FIGS. 7 and 8, a further configuration of the speaker mounting assembly 1 of the present disclosure is shown, in use, to mount a speaker enclosure 3 on a surface, such as table top (not shown). As before the same speaker mounting assembly 1 is used, comprising a shaped bracket 17. In this configuration, the inner surface that is substantially V-shaped forms legs 17a, 17b that rest directly on the table top and the speaker enclosure 3 is supported on one of the opposing, outer surfaces 21 of the bracket 17. The V-shape of the bracket 17 comprises a flat strip 23 at the apex of the V-shape, which in further possible configurations allows a speaker enclosure to be fitted to each side of the bracket when it is resting on a surface. Thus, a user is able to use the same mounting assembly to meet their chosen acoustic requirements. In the configuration shown in FIGS. 7 and 8, sound is emitted from only one side of the speaker mounting assembly 1. However, by mounting a speaker to each side of the speaker mounting assembly 1, sound would be emitted from both sides of the speaker mounting assembly 1.

Referring to FIGS. 9 and 10, in a further installation configuration, the speaker mounting assembly 1 is used for floor mounting of the speaker enclosure 3 or wall/ceiling mounting on a pivotable arm. FIG. 9 shows a base 42 on which is held a spike 41 and a floor mounted stand 42a which is fixed or rests on the floor. In alternative uses, the spike 41 is directly inserted into the ground.

An upper part of the spike 41 is pivotably connected to a support arm 40 by a pivot 43. The pivot 43 allows for movement of the support arm 40 into the desired orientation. The speaker mounting assembly 1 is fixed to the support arm 40 along the flat strip 23 (not shown in FIGS. 9 and 10) at the apex of the V-shaped bracket 17, via the fixing holes 25. In still further configurations as shown in FIG. 10, the spike 41 is removed to allow the base 42 of the pivotable support arm 40 to be bolted to a support surface, such as a wall, a floor, or a ceiling. This allows a speaker enclosure 3 mounted on the pivotable support arm 40 to be carefully positioned to achieve the required direction of sound emitted.

Referring to FIG. 9, in use the floor mounted speaker mounting assembly 1 is erected before the speaker enclosure 3 is attached to the bracket 17. As previously described, the apex on the non-sound-emitting face 7 of the speaker enclosure 3 is fitted to sit within the inner, V-shaped, speaker-receiving surface 19 of the mounting assembly 1. The speaker enclosure 3 is fixed in the required position using suitable fixing means through the speaker enclosure 3 to the bracket 17, such as screws.

Referring to FIG. 10, in use the wall-mounted speaker mounting assembly 1 is erected before the speaker enclosure 3 is attached to the bracket 17. As previously described, the apex on the non-sound-emitting face 7 of the speaker enclosure 3 is fitted to sit within the inner, V-shaped, speaker-receiving surface 19 of the mounting assembly 1, whilst there is a recess (31a shown in FIG. 3) to allow cables/wiring to pass between the speaker enclosure 3 and the mounting assembly 1. The speaker enclosure 3 is fixed in the required position within the bracket 17 using suitable fixing means through the speaker enclosure 3 to the bracket 17, such as screws. With the speaker enclosure 3 mounted to the bracket 17, the pivotable support arm 40 is moveable about the pivot 43 to achieve the required direction of sound output.

Within this specification, the term “about” means plus or minus 20%; more preferably, plus or minus 10%; even more preferably, plus or minus 5%; most preferably, plus or minus 2%.

The above described embodiment has been given by way of example only, and the skilled reader will naturally appreciate that many variations could be made thereto without departing from the scope of the claims.

1. A speaker mounting assembly for mounting a speaker in multiple configurations, the speaker mounting assembly comprising:
a bracket having a substantially V-shaped profile,
wherein the bracket comprises:
a first mounting plate and a second mounting plate meeting at a flattened vertex, wherein the flattened vertex forms a third mounting plate, and
fixing apertures in each of the first, second and third mounting plates.

2. The speaker mounting assembly according to claim 1, wherein the angle between the internal walls of the first mounting plate and the second mounting plate is about 90 degrees.

3. The speaker mounting assembly according to claim 1, wherein the internal walls of the first mounting plate and second mounting plate are planar and the outer walls of the first mounting plate and the second mounting plate are multifaceted.

4. The speaker mounting assembly according to claim 1, wherein the speaker mounting assembly comprises a shaped bracket having an inner receiving surface that is substantially V-shaped and an opposing, outer surface that is also substantially V-shaped but is truncated to comprise a flat strip at the apex of the V-shape.

5. The speaker mounting assembly according to claim 1, wherein the third mounting plate has a stepped configuration.

6. The speaker mounting assembly according to claim 1, wherein the third mounting plate comprises a recess.

7. The speaker mounting assembly according to claim 1, wherein the third mounting plate comprises a cuboidal recess.

8. The speaker mounting assembly according to claim 1, wherein the third mounting plate comprises a cuboidal recess which is centrally positioned along its length.

9. The speaker mounting assembly according to claim 1, further comprising at least one spacer.

10. The speaker mounting assembly according to claim 9, wherein each spacer comprises a rigid material.

11. The speaker mounting assembly according to claim 1, further comprising a first spacer at a first end of the speaker mounting assembly and a second spacer at a second end of the speaker mounting assembly.

12. The speaker mounting assembly according to claim 1, further comprising at least one removable triangular cover.

13. The speaker mounting assembly according to claim 1, further comprising two removable triangular covers, wherein each removable triangular cover is attached at an open end face of the speaker mounting assembly.

14. The speaker mounting assembly according to claim 1, further comprising a detachable support arm.

15. The speaker mounting assembly according to claim 14, further comprising a removable spike at one end of the detachable support arm.

16. The speaker mounting assembly according to claim 14, wherein the detachable support arm is pivotable.

17. The speaker mounting assembly according to claim 15, wherein the detachable support arm is pivotably mounted to the bracket.

18. The speaker mounting assembly according to claim 14, wherein the detachable support arm comprises a base, a pivot point and a mounting arm.

19. The speaker system comprising at least one speaker mounting assembly according to claim 1, and at least one speaker attached thereto.

20. The speaker system comprising at least one speaker mounting assembly according to claim 1, and at least one speaker enclosure attached thereto, wherein the or each speaker enclosure comprises a speaker.

21. The speaker system according to claim 20 comprising at least one spacer, wherein the or each spacer traverses a gap between the speaker mounting assembly and a speaker enclosure attached thereto.
